(19) United States
(12) Patent Application Publication
(10) Pub. No.: US 2006/0022142 A1
(43) Pub. Date: Feb. 2, 2006

(54) Detector surface for low-energy radiation particles

(75) Inventor: Vivian Noel Edward Robinson, New South Wales (AU)

Correspondence Address: LADAS & PARRY, 26 WEST 61ST STREET, NEW YORK, NY, 10023, US

(73) Assignee: ETP SEMRA PTY. LTD.

(21) Appl. No.: 11/176,942

(22) Filed: Jul. 7, 2005

Related U.S. Application Data
(60) Provisional application No. 60/587,207, filed on Jul. 12, 2004.

(51) Int. Cl. G01T 1/20

(52) U.S. Cl. 250/370.11

(57) ABSTRACT

An improved surface for detecting low-energy radiation particles has high performance phosphor particles partially embedded into a light guide material to optically couple the light guide material and the phosphor particles. This arrangement addresses photon signal losses, which occur when phosphor particles rest upon the surface of the light guide. The improved optical coupling enables the photons generated by the phosphor particles to be efficiently transferred to the light guide, and then to a photomultiplier tube or other device as required.

### FIELD OF THE INVENTION

The present invention relates to the detection of low-energy radiation particles, such as electrons. These particles are typically generated in electron optical devices and radiation generating devices.

### BACKGROUND

Detection of low-energy radiation particles is important in many scientific fields. Consequently, improvements in the detection of these particles can be of significant advantage in such fields.

One important type of detector surface for low-energy radiation particles involves scintillation materials that emit photons whenever radiation particles impinge upon the surface. Radiation particles, typically electrons, impinge upon a scintillator surface consequently emitting photons, which are directed via a light guide to a photomultiplier tube. The photomultiplier tube converts the photons to electrons. This electron signal passes to an electronic amplifier, which enables the signal to be used for imaging purposes.

There are many factors that influence the efficiency of a detection surface. Among the most important factors are the efficiency of the scintillator (the number of photons emitted per unit of energy for each incident particle), and the collection efficiency of the emitted photons.

Different scintillation materials emit different amounts of photons for the same amount of radiant energy incident upon them. The list of scintillation materials that emit photons when struck by incident radiation particles include plastic encapsulated toluene, yttrium aluminate gamate (YAG), yttrium aluminate perovskite (YAP), and thallium activated sodium iodide, among others.

There are also an array of materials that are known as “phosphors”. Phosphors differ from scintillation materials in that the term phosphors is typically applied to materials that are in powder form. The powdered nature of phosphors means they cannot transmit photons directly to the photomultiplier tube. Due to their other useful properties, however, these phosphors are useful in the detection of low energy radiation particles. Phosphors, in the context of scintillator materials, includes P47—the commercial name for a high performance phosphor, powdered YAP, and powdered YAG, and other similar powdered materials that emit photons when bombarded by radiation particles. Phosphors can comprise particles of one material, or a combination of materials.

Some phosphor materials emit more photons than other phosphor materials. P47 can emit more photons than any other material, for the same radiation dose. Other phosphors have different unique properties over other scintillation materials, such as a short decay time, thus allowing for a rapid response. A wide range of scintillator materials, and scintillator arrangements are used in various applications due to these differing characteristics.

A common application for scintillation materials is scanning electron microscopy (SEM), in which the above-described scintillator detectors are used. Much experimentation has been conducted to achieve improved scintillator detectors. There are many factors that influence the detection efficiency of low-energy radiation particles. Among the most important factors are the efficiency of the scintillator (the number of photons emitted per unit of energy for each incident particle) and the collection efficiency of the emitted photons.

Phosphors are currently utilised in the detection of low energy radiation particles in at least two different methods. The first technique involves deposition onto an optically transparent light guide surface. This is often achieved by agitating the phosphor powder in a liquid and allowing the powder to settle onto the surface. The liquid is then removed. The desired result can be difficult to achieve, and the phosphor particles often fall off the light guide material as a matter of course, giving non-uniform illumination. A related approach includes spraying a mixture of a phosphor material and a suitable liquid onto the surface of a light guide material. Similar limitations beset this alternative technique.

The second method addresses some of the difficulties associated with the above-mentioned first method by detecting emitted photons from the input side of the radiation rather than from the opposite side to which the particles strike. Refer, for example, to U.S. Pat. No. 6,211,525 issued Apr. 3, 2001 in the name of KE Developments Limited, and entitled “Detector devices”. The technique described in this reference has the advantage that phosphor powders can be used, but is found to have difficulties in the amount of light that is collected by the light guide.

Accordingly, a particularly desirable objective is achieving scintillator detectors that have improved efficiency, and which preferably address the above-mentioned difficulties associated with existing detectors.

### SUMMARY

A fundamental insight that informs the improved detector and associated manufacture described herein concerns the interaction between phosphor particles and light guide materials. Existing detector surfaces using phosphor particles have a relatively weak optical coupling between phosphor particles and the light guide material due to various reasons. Furthermore, the phosphor particles typically used are irregular in shape, which reduces the physical contact and optical coupling between phosphor particles and the light guide material.

There exists the possibility of improving the signal output of detectors using phosphor scintillators, if one can approach the objective of providing an approximately uniform monolayer layer of phosphor powder that is continuous over the surface of the light guide. Such a layer must be physically bound to the light guide and make optical coupling to give maximum photon transmission from the phosphor particle to the light guide. This surface is desirably also stable in vacuum, as such an environment is the usual origin of low-energy radiation particles.

Particular deficiencies of existing detectors can be significantly alleviated by suitably impregnating the phosphor particles into the light guide material. The phosphor particles are as a consequence partially embedded in the light guide material, thereby achieving improved optical coupling between the phosphor particles and the light guide material.

This can be achieved according to various techniques, and for different combinations of phosphor particles and light guide materials.

Optically coupling the phosphor particles to the light guide material can be achieved in different ways. As examples, the particles can be partially embedded in the surface of the light guide material, or adhered to the surface of the light guide material using a transparent adhesive.

Phosphor particles can be of any suitable radiation-emitting material. Light guide materials can be either organic (polymethyl methacrylate, polyvinyl toluene or similar) or inorganic (glass, quartz or similar).

### DESCRIPTION OF DRAWINGS

FIG. 1 is a schematic representation of phosphor powder particles deposited on, and partially embedded in, the surface of a light guide.

FIG. 2 is a schematic representation of phosphor particles deposited on, and partially embedded in, a transparent adhesive adhered to the surface of the light guide.

FIG. 3 is a schematic cross-sectional representation of metal grid segments deposited onto a light guide having partially embedded phosphor particles.

FIG. 4 is a schematic plan view representation of FIG. 3.

FIG. 5 shows comparative detector performance.

### DETAILED DESCRIPTION

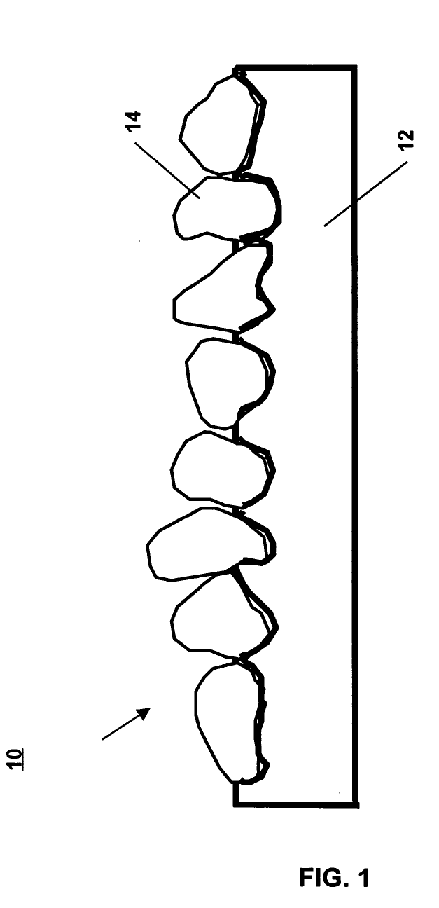

FIG. 1 schematically illustrates an enlarged view of phosphor particles 14 deposited on and partially embedded in the surface of a light guide 12. The production of a single monolayer, as illustrated, is difficult to achieve using powder deposition techniques, as many techniques leave several layers of phosphor powder on the surface of the light guide. The phosphor particles 14 can be various sizes, and are irregularly shaped when obtained from commercial suppliers.

Relatively coarse particles, having average dimensions of less than 0.1 mm, can be used. The light guide is temporarily softened to a thickness of the order of half the average dimensions of the phosphor particles. While in the softened state, phosphor particles are applied to the surface with a pressure sufficient to force the particles into the softened surface. Softening the surface only to the extent of about half the average dimensions of the phosphor particles assists in obtaining a covering layer of particles having a thickness of no more than one particle. The extent to which the surface is softened is a matter of estimation, through attempting to soften to a depth of between a quarter to twice the average dimensions of the phosphor particles provides a working guide during manufacture. Applying the powder uniformly over the surface means that the layer is also approximately uniform, as well as only one layer thick.

Organic Light Guides

The surface of many organic light guides can be softened by applying a solvent suitable to their surface. With the careful choice of light guide material and solvent, a small amount of solvent can be applied to the surface of the light guide to soften the surface, as the solvent penetrates into the organic plastic material. While the surface is soft, sufficient phosphor particles are pressed into the surface. The powder then sticks to the softened surface, as the surface gives way to the pressure of the applied powder. The surface of the light guide makes direct contact with a large percentage of the surface of the individual phosphor powder particles. This is preferably done in a manner that only softens the surface sufficiently to enable a single layer of phosphor powder particles to be partially and uniformly embedded into the surface of the light guide. More than a monolayer can be used, as particles 14 above the first layer can still optically couple with the light guide material 12. This effect is diminished beyond two or three layers. In practice, optimum phosphor embedding occurs with approximately 50% of the phosphor particles embedded into the light guide.

Suitable materials and solvents can include poly methyl methacrylate and acetone, poly vinyl toluene and toluol. Other suitable solvents include chloroform, or indeed any solvent that mixes with or temporarily dissolves and softens an optically transparent material. The thickness of the layer softened by this technique should be less than the average dimensions of the phosphor particles.

This increased contact area between the particles 14 and the light guide 12 offers improved transmission of photons between the individual phosphor particles 14 and the light guide 12. Once the surface has solidified again, the phosphor particles 14 will be well embedded into the light guide 12. Of course, the phosphor particles 14 need to be exposed to incoming radiation particles 10.

Inorganic Light Guides

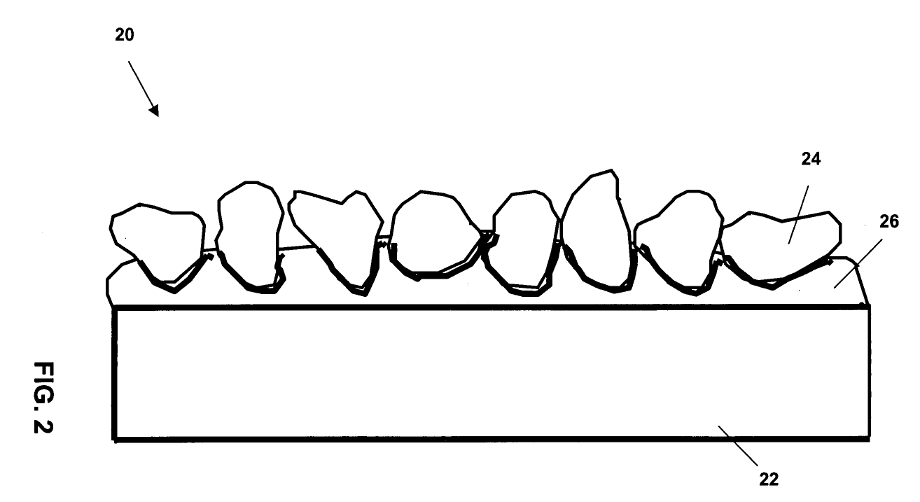

FIG. 2 schematically represents a detecting surface having a light guide 22 and particles 24 that are optically coupled by a transparent adhesive 26. The particles 24 are partially embedded in the transparent adhesive 26, and the adhesive 26 is adhered to the light guide 22. This partial embedding extends the contacting surface area between the particles 24 and the transparent adhesive 26, which improves the efficiency of optical coupling between the particles 24 and the transparent adhesive 26. It also physically bonds the phosphor powder particles to the light guide. The transparent adhesive optically couples with the light guide 22.

A suitable amount of softening of the light guide 22 is desirable. Too much softening can cause the light guide material to flow around many layers of phosphor particles 24, producing an optically opaque surface, as phosphors particles 24 are generally not good transmitters of photons. On the other hand, too little softening can result in poor coverage of phosphor powder over the surface of the light guide. The conditions required for this vary with the nature of the light guide, but generally softening to a thickness of about the half the average phosphor powder grain size can be considered adequate. This is not critical, and any softening of the surface of the light guide, either by the application of a solvent or of an optically transparent adhesive, to the surface of the light guide is considered advantageous to this technique.

Softening using an appropriate solvent or optically transparent adhesive is one method of softening. Other methods can also be used as required. Such alternate methods include heating the surface of the light guide material, or applying a thermosetting resin on the light guide. Heat can adequately soften many materials and have the same effect. Further, a combination of heat, and the application of an adhesive or solvent is also possible.

Metal Grids

Both light guide materials and phosphor powders are generally electrical insulators. Accordingly, when particles such as electrons impinge upon the surface, electrical charge can accumulate, which distorts the electric field around the detector surface.

One method for addressing this phenomenon is to apply a conductive metal grid to the detector surface before applying phosphor particles. The metal grid should have fine spacing to avoid localized charge accumulation, though freely transmit incoming radiation particles. A 90% transmission grid with 70 lines per inch has satisfactory characteristics, although many other grids are also satisfactory.

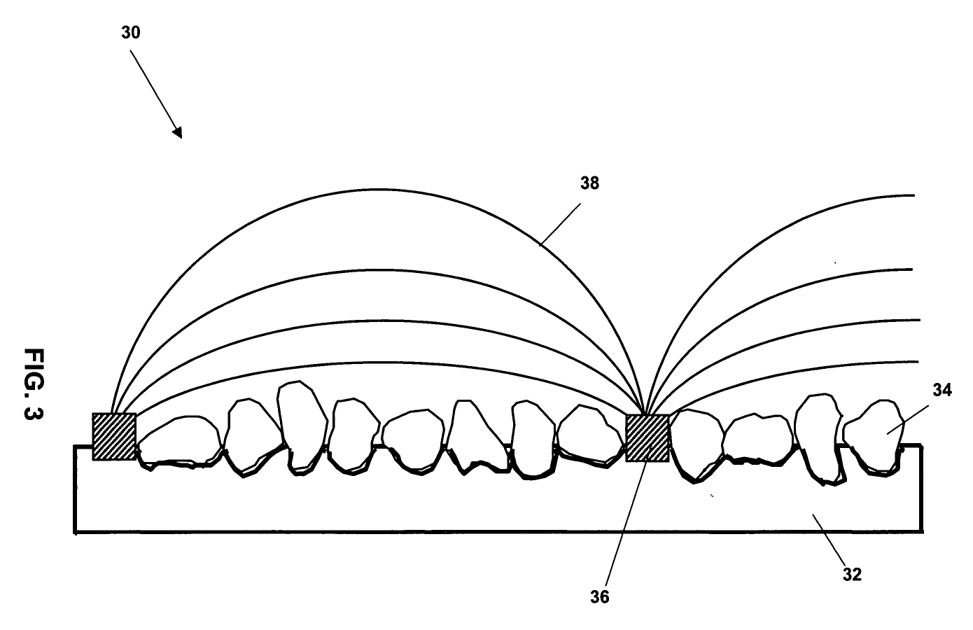

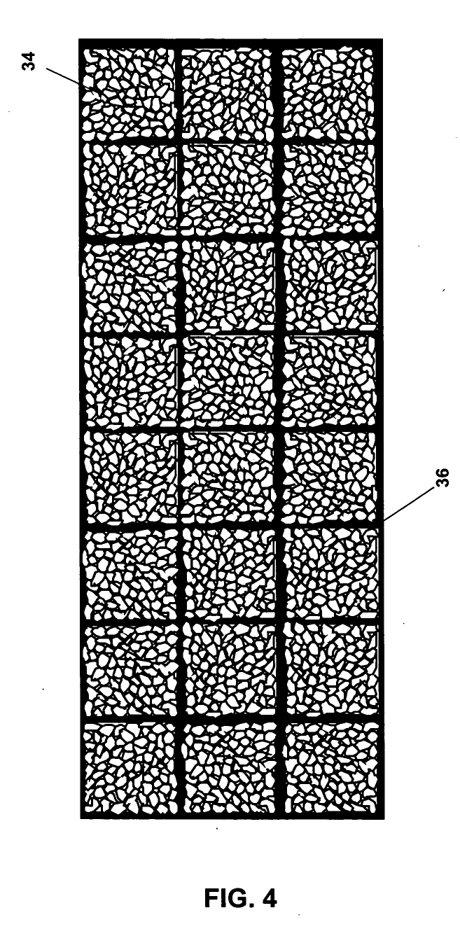

FIGS. 3 and 4 schematically illustrate a cross-sectional view, and a plan view, of a metal mesh deposited on a detector surface.

The metal grid 36 is deposited on the light guide 32, with the phosphor particles 34 partially embedded in the light guide 32. The metal grid 36 conducts away any accumulated charge, thus limiting the extent to which an electrostatic field, depicted by lines of electrostatic potential 38, can spread away from the insulating surface of phosphor powder.

Use of a metal grid 36 also appears to limit the amount of penetration of solvent into the light guide 32, and produces a more uniform phosphor powder layer than is achieved without the grid 36.

Use of a metal grid 36 also allows a voltage to be applied to the grid 36, the rationale for which is described as follows. The energy of incident radiation particles may in some cases be too low to generate sufficient photons when they impinge upon the phosphor powder. The number of photons can be increased by increasing the energy of these radiation particles before the radiation particles impact upon the detector surface.

Application of a voltage to the metal mesh 36 can be used to energize the incident radiation particles. The applied voltage can be anything from a few volts positive to over 10,000 volts positive to attract electrons and other negatively charged particles, such as negatively charged ions. Where positively charged particles such as protons, alpha particles or other positively charged ions are involved, a negative voltage can be applied to the metal mesh 36 to attract these radiation particles.

Results

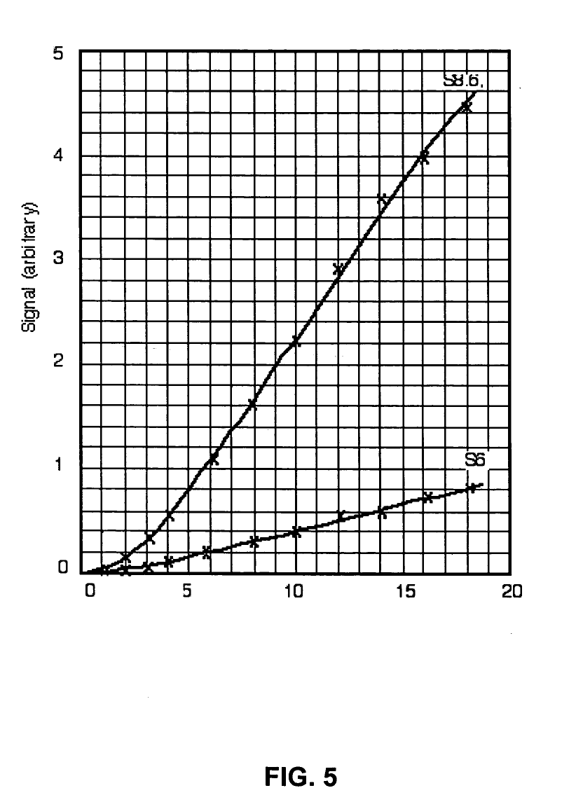

Increases in the efficiency of signal detection by a factor of up to fifty times can be achieved using the described detector design, compared to other detector designs using the same phosphor material. Referring to FIG. 5, a plot of signal (in arbitrary units) and accelerating voltage (in kV) for a detector embodying the invention S8.6 is shown. A corresponding characteristic for a known detector design of the assignee—known as the series 6 Robinson detector (S6)—is also shown. With a detector thickness of 2.5 mm, the S8.6 scintillator response is superior by at least a factor of four. This increase in efficiency is attributed to optically coupling phosphor particles and light guide material in the manner described herein.

Applications

One particular application of the described detector surface is scanning electron microscopes (SEMs). SEMs use a beam of low-energy electrons scanned over the surface of an object or specimen. Some of the electrons are scattered back by the surface of the object or specimen. The number of electrons backscattered is usually well under half the number of incident electrons, and their average energy is also usually well under half the energy of the incident electron beam.

As an example, if an average of 15% of electrons are backscattered and each electron has an average of 15% of the incident beam energy—typical of an organic/carbon surface being examined—only about 2% of the energy of the incident beam is available to be detected. Detection requirements are thus quite exacting, as any lost signal results in an inability to “see” features of interest. Improvements in detector efficiency improve the image that is ultimately obtained.

Many low energy electrons, called secondary electrons, are also detected in a SEM. These secondary electrons rely upon an attracting positive voltage to generate a signal. The conversion efficiency of the electrons to photons is still important in generating a satisfactory image. The use of the described detector surface can enhance the capability of this type of detector to produce satisfactory images.

### CONCLUSION

Various alterations and modifications can be made to the techniques described herein, as would be apparent to a person skilled in the art.

I claim:

1. A method for manufacturing a detector surface for radiation particles comprising impregnating the surface of a light guide material with phosphor particles, whereby the phosphor particles are partially embedded in the surface of the light guide material to increase the optical coupling and physical bonding between the phosphor particles and the light guide material.

2. The method of claim 1, further comprising the step of softening the surface of the light guide material prior to impregnating the material with phosphor particles.

3. The method of claim 2, wherein the surface of the light guide material is softened by applying a solvent to the surface of the light guide material.

4. The method of claim 2, wherein the surface of the light guide material is softened by heating the surface of the light guide material.

5. The method of claim 2, wherein the surface of the light guide material is softened to a depth from approximately one quarter of to twice the average dimensions of the phosphor particles.

6. The method of claim 2, wherein the surface of the light guide material is softened to a depth of approximately one half of the average dimensions of the phosphor particles.

7. The method of claim 1, further comprising depositing a conductive mesh on the surface of the light guide material.

8. The method of claim 7, further comprising electrically earthing the conductive mesh deposited on the surface of the light guide material.

9. The method of claim 7, further comprising applying a voltage to the conductive mesh deposited on the surface of the light guide material to attract oppositely-charged radiation particles towards the surface of the light guide material.

10. The method of claim 1, further comprising the step of applying a transparent adhesive to the surface of the light guide material prior to the application of the phosphor powder particles in the manner described in claim 1.

11. The method of claim 1, further comprising depositing a conductive mesh on the surface of the light guide material.

12. The method of claim 1, further comprising the step of applying a thermoplastic substance to the surface of the light guide.

13. A detector for detecting radiation particles comprising a light guide material, and phosphor particles impregnated in the surface of the light guide material to increase the optical coupling between the phosphor particles and the light guide material.

14. A scanning electron microscope for detecting electrons comprising a detector having surface manufactured according to the method of impregnating the surface of a light guide material with phosphor particles, whereby the phosphor particles are partially embedded in the surface of the light guide material to increase the optical coupling and physical bonding between the phosphor particles and the light guide material.

15. A scanning ion mircoprobe for detecting emitted particles comprising a detector having a surface manufactured according to the method of impregnating the surface of a light guide material with phosphor particles, whereby the phosphor particles are partially embedded in the surface of the light guide material to increase the optical coupling and physical bonding between the phosphor particles and the light guide material.

16. A night vision scope comprising a detector having a surface manufactured according to the method of impregnating the surface of a light guide material with phosphor particles, whereby the phosphor particles are partially embedded in the surface of the light guide material to increase the optical coupling and physical bonding between the phosphor particles and the light guide material.
